(19) United States
(12) Patent Application Publication
(10) Pub. No.: US 2017/0028349 A1
(43) Pub. Date: Feb. 2, 2017

(54) Method and Apparatus For Liquid Extraction

(71) Applicant: MURDOCH UNIVERSITY, Rockingham, Western Australia (AU)

(72) Inventors: Geatan BLANDIN, Maulevrier (FR); Pierre LECLECH, Botany (AU)

(73) Assignee: Murdoch University, Rockingham, Western Australia (AU)

(21) Appl. No.: 15/304,011

(22) PCT Filed: Apr. 14, 2015
(86) PCT No.: PCT/AU2015/050172

§ 371 Date: Oct. 13, 2016

(30) Foreign Application Priority Data
Apr. 14, 2014 (AU) 2014901362
May 8, 2014 (AU) 2014901711

(51) Int. Cl. B01D 61/00; C02F 1/44; B01D 61/02

(52) U.S. Cl. CPC B01D 61/005; B01D 61/027; C02F 1/445; C02F 1/442; B01D 2311/25; B01D 2313/24; B01D 2325/34; C02F 2103/08

(57) ABSTRACT

An osmotic separation process for the extraction of a solvent from a first solution with low osmotic pressure, in a first compartment to a second solution with higher osmotic pressure in the second compartment. The first solution and the second solution are separated by a semi-permeable membrane. An hydraulic pressure gradient is applied and on the first compartment to enhance the water permeation from the first solution to the second solution

### FIELD OF THE INVENTION

The present invention relates to the apparatus and methods for the extraction of liquid from a first solution (feed) with low osmotic pressure to a second solution (draw) with higher osmotic pressure using membrane technology and addition of hydraulic pressure driving.

### BACKGROUND OF THE INVENTION

As the population of the earth increases the need for fresh potable water also increases while the availability of freshwater is decreasing due to contamination of freshwater supplies by human activity. In many parts of the world technological solutions have been employed to supply sufficient potable water for growing populations.

One of the dominant technologies applied in the world today to obtain potable water is a membrane based-process known as reverse osmosis (RO). To fully understand the concept of RO it is required to firstly have an understanding of the natural phenomena osmosis. The oxford dictionary defines osmosis as:

“The process by which molecules of water or another solvent tend to pass through a semipermeable membrane into a region of greater solute concentration, so as to make the concentrations on the two sides of the membrane more nearly equal”

The process ‘osmosis’ is a naturally occurring process with a driving force associated with the movement of the solvent molecules from the region of low total dissolved solids (low TDS) to the region of greater solute concentration (high TDS) wherein the force is called osmotic pressure. RO process requires a force to overcome the natural osmotic pressure of the solutions to allow water permeation through a membrane while contaminants are retained and the process incurs a significant energy cost. The pressure required to overcome natural osmotic pressure is related to the relative concentrations of the solvent stream and the solute containing stream. In a seawater RO plant where the solute containing stream is seawater and the solvent stream is called permeate, a pressure of approx. 6-8 MPa is required to overcome the natural occurring osmotic pressure.

One of the proposed solutions to address this large energy cost is to work with the natural osmotic pressure and harness osmosis—called Forward Osmosis in industry. The use of osmotic pressure driven processes such as forward osmosis (FO) and pressure retarded osmosis (PRO) has recently regained attention from researchers and industrialists. In such systems, the difference of solute concentrations (also called osmotic pressure) between two liquids namely as feed and draw solutions separated by a selectively permeable membrane acts as the driving force, allowing the net movement of water through the membrane, while most of the solute molecules or ions are rejected and don't pass through the membrane.

The concept of FO has been studied for many applications, including treatment of industrial wastewaters through the concept of sewer mining or osmotic membrane bioreactor (OMBR), concentration of liquid foods in the food industry, concentration of landfill leachate, enrichment of pharmaceutical products (e.g. protein and lysozymes), direct fertigation in which diluted fertilizer draw solution is directly used in irrigation, and energy production thanks to osmotic microbial fuell (OSmFC) cell or PRO

Extensive research has also been recently developed to evaluate the use of FO for reclaiming wastewater for potable reuse in life support systems, for desalinating seawater and for purifying water in emergency relief situations.

One promising application of FO for wastewater treatment is in the FO membrane bioreactor called OMBR. The OMBR process can employ seawater as a draw solution due to its low cost and high availability in coastal areas. After osmotic dilution, the diluted draw solution can be reconcentrated by a post-treatment process (e.g. RO) to produce fresh water. FO can be operated in an osmotic dilution mode (i.e., no requirement of draw solution reconcentration) to recover water from waste streams and produce a new source of water for beneficial reuse of impaired water sources. The ideal process of FO in osmotic dilution mode includes water recovery from drilling wastewater (e.g. wastewater generated during oil and gas exploration) and for simultaneous concentration and volume reduction of the waste stream to be disposed of (e.g. recovery of water from urine in space).

The use of FO has been proposed to process typical liquid food streams, for instance, concentration of sugar solutions derived from sugar cane or sugar beet, concentration of fruit juices and whey protein. During FO process, when the sucrose solution is used as a feed solution coupled with a draw solution which has a higher osmotic pressure, for instance sodium chloride, NaCl, the sucrose is concentrated due to the net flow of water from sucrose feed solution to the draw solution. The concentrated sucrose solutions in particular are widely used in food engineering processes, such as in the formulation of jams and marmalades, bakery products and candies. When compared with RO to achieve the higher concentration factor—a critical performance criterion in sucrose or other food concentration processes, the energy costs associated with RO increased with the increase in concentration factor—making FO process more favourable.

In one configuration that has been proposed FO for seawater desalination can be considered based on the use of an artificial draw solution with a very high osmotic pressure that induces a net flow of water from seawater. Notwithstanding the efforts to develop more efficient draw solutions, the need to regenerate the artificial draw solution negatively affects the financial viability of this type of applications.

Alternatively, FO/RO hybrid process is a promising method to combine water reuse and desalination. In this configuration, FO is considered as a pre-treatment step of RO, the seawater being diluted by an impaired water source passing through the semipermeable membrane (in FO mode) into the RO feed. Ultimately, the overall energy consumption is being decreased due to the lower pressure required to drive the RO system. Confluence of two water streams (with high and low TDS) is a requirement for the workability of this concept. Rain water runoff, ground water and municipal sewage waters (treated or not) have been identified as potential low TDS water (or feed source).

In FO, water transport through the membrane is limited by a number of phenomena, in addition to external and internal concentration polarization (ECP and ICP), the deposition of soluble, colloidal and solid materials present in the feed solution on the membrane surface can strongly impact the hydraulic efficiency of the process. Finally, the reverse salt passage (diffusing from draw to feed solutions) is also responsible for the reduction of the net difference of the osmotic pressure (n) value across the membrane. These phenomena are mainly due to the current design of the FO membranes. The ideal membrane for FO application should achieve high water flux, and salt rejection, have minimal internal CP and high mechanical strength to support hydraulic pressure.

In the 1990s, with the development and commercialisation of a specific FO membrane by Osmotek (Now Hydration Technology Innovations, HTI) significant improvement in water flux has been observed. This flat-sheet membrane made of cellulose triacetate (CTA) differs from RO membranes by having a thickness of only 50 μm limiting ICP. Since then, direct osmosis (Forward Osmosis & Pressure Retarded Osmosis), is more attractive and is leading to intensive and growing research to further limit CP.

New approaches have been used to develop Thin-Film Composite (TFC) membranes consist of a selective polyamide layer formed by interfacial polymerisation on top of a polysulfone porous substrates. TFC membranes have been shown to produce higher water fluxes due to more flexibility in selecting active and support layer leading to less tortuosity or more porosity. The concept of TFC membrane has been extended to the synthesis of double skinned layer leading to lower ICP and fouling. Another approach for TFC membrane improvement was the development of a hydrophilic support layer leading again to lower ICP and subsequent higher water flux and lower salt rejection. The use of nanoparticles fibres as a support layer is also a new way to improve TFC membranes. Recent works also mentioned the Layer-by-Layer approach (LbL) that allowed the formulation of tailored made FO membranes. Alternatively, recent promising works was also published on biomimetic FO membranes embedded with Aquaporin Z and carbon nanotubes.

The use of high permeability Nanofiltration (NF) in FO application was firstly proposed in 2007. When FO tests were conducted with the fabricated single-layer polybenzimidazole (PBI) NF hollow fibre (HF) membranes with a mean pore size of 0.32 nm, it was observed that the water flux performance was as high as 9.02 L·m⁻²·h⁻¹ when 5 M MgCl₂ (i.e., osmotic pressure of approximately 1148.7 bar) was used as a draw solution. Regardless of a very high osmotic pressure of the draw solution used, the water flux performance was poor in FO tests due to ICP within the thick support layer. The improved water flux (>20 L·⁻²·h⁻¹) was achieved when PBI NF HF membrane was modified by crossed-linking with p-xylylene dichloride (1.0 wt % in ethanol) to achieve a thinner wall (i.e. thinner support layer) in order to reduce ICP effect.(Similarly, based on the LbL approach, new membranes were developed with NF-like selective layer to limit CP. Interestingly, improved water flux (>10.L·⁻²·h⁻¹) and good salt rejection (>90%) were obtained but only with divalent salts. Therefore, although the results seem promising in terms of improved water flux, these new materials are not suitable for practical applications in which sea water, composed mainly of monovalent salts, is used as a draw solution.

Thus, despite this extended work on membrane development, to our knowledge, the industrial implementation of FO process is still limited by its lack of performance in water permeation and high reverse salt diffusion. As a consequence, despite potential energy savings in comparison to RO, extended investment (high membrane surface area) or operating costs (in case of draw replenishment) are needed, affecting FO economic viability.

There is thus a need in the field of forward osmosis for developing a process that can exhibit an improved water permeation flux on the one hand and reduction of reverse solute flux (i.e., solute leakage) on the other.

### SUMMARY OF THE INVENTION

An osmotic separation process for the extraction of solvent/water from a first solution (feed) with low osmotic pressure in a first compartment to a second solution (draw) with higher osmotic pressure in the second compartment, where a hydraulic pressure is applied, hydraulic pressure being higher on the first compartment than on the second compartment to enhance the water permeation from the first solution to the second solution, where the first solution and the second solution are separated by a semi-permeable membrane defined commonly as NF membrane.

The invention could be of application in any process considering the water transport from a low salinity gradient solution to a higher salinity gradient, being for osmotic dilution, osmotic concentration, not exclusively but particularly in the context of food applications (particularly in liquid foods concentration), pharmaceutical applications (enrichment of pharmaceutical products, e.g. protein and lysozymes), water purification, reuse and recovery from impaired water sources, energy production and desalination.

In some embodiments of the invention, the feed solution or the aqueous target from which solvent is to be extracted, herein is non-limiting examples from a low salinity water, waste water, storm water, recycled water, fruit juices. The draw solution with a higher osmotic pressure can be from any source, herein is non-limiting examples from a high solute water, seawater, RO brine, surface water, groundwater.

In order to effect the invention there is provided an assisted osmotic separation process for the extraction of a solvent from a first solution with low solute concentration into a second solution with higher solute concentration separated by a semipermeable membrane wherein a hydraulic pressure gradient is applied to the first solution.

In the above process the hydraulic pressure gradient as in the same orientation and the osmotic pressure gradient.

The intention is not intended to be limited to the source of the pressure and it could be form such source as gravity or pumping or even osmotic pressure for another system.

In some embodiments of the invention, it could be used either as a single process step or in a more complex system including possibly as a pre-treatment or post-treatment step of any of the feed and draw solutions used.

The advantage of the present invention is that after osmotic dilution, the diluted draw solution can be reconcentrated by a post-treatment process (e.g. RO) to produce fresh water. Due to the lower osmotic pressure of the draw solution (i.e., after osmotic dilution), less energy is required by RO process.

Equally the process could be applied downstream with a FO step to further enhance the water permeation.

In some embodiment of the invention, only the feed solution from the first compartment is pressurised. The applied hydraulic pressure is comprised but not limited to 1 to 20 bar to have a significant impact on water permeation flux but limiting the additional energy costs due to the pressurisation. In a preferred embodiment the hydraulic pressure gradient is in the rage of the range of 0.5 to 15 bar. In a third configuration the applied hydraulic pressure gradient is in the range to 1 to 10 bar.

In some embodiment of the invention, the pressurisation on the first compartment is occurred through a pump that also assists in solvent transfer from a first compartment to a second compartment through the membrane separation system.

In some embodiment of the invention, the chosen membrane can be a commercial membrane, a modified commercial membrane or a membrane specifically developed for the application satisfying the criteria of molecular weight cut-off comprised in-between 50 and 1000 Dalton. Membranes meeting this molecular weight cut off are commonly referred to a Nano filtration membranes.

In some embodiment of the invention, the membrane used could be flat sheets, a hollow fibre membrane, or any kind of shape that allows the presence of water/solvent on both sides of the membrane.

In some embodiment of the invention, the membrane could be used in a flat configuration, such as flat sheets, in a spiral-wound configuration, a hollow fibre module or any other suitable configuration that allows the presence of feed and draw solutions on both sides of the membrane.

In some embodiment of the invention, the membrane could be immersed in one of the two solutions.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which

FIG. 1: Schematic drawing of PAO-NF concept

FIG. 2: Schematic treatment of PAO-NF used as pre-treatment of RO

FIG. 3: Schematic drawing of PAO-NF for osmotic dilution of fertiliser

FIG. 4: PAO-NF used as a second step of a FO process

FIG. 5: Schematic drawing of PAO-NF for osmotic concentration of sugar (sucrose)

FIG. 6: Schematic representation of the PAO filtration rig

FIG. 7: Schematic of the test cell

### BRIEF DESCRIPTION OF THE TABLES

Table 1: Initial economic comparison of FO and PAO with commercial CTA FO and NF1 membranes

Table 2: Detailed membrane characteristics of both NF and HTI membranes used

Table 3: Feed solution compositions

Table 4: CTA FO vs. NF1 on FO and PAO mode

Table 5: Water permeation flux (L·m-2·h-1) and reverse solute diffusion (g·L-1) during PAO-2 bar experiments conducted for NF1 membrane at AL-FS and AL-DS configurations

Table 6: Water permeation flux (L·⁻²·h⁻¹) performances of diverse NF membranes with three applied hydraulic pressures

Table 7: Permeation flux for four feed solutions using NF1 membrane at 2 bar operating pressure

Table 7: Separation performances of tested CTA FO membrane and commercial NF membrane

Table 9: Modelled water permeation flux (L·⁻²·h⁻¹) performances of potential membrane development for PAO-NF

Table 10: Modelled needed membrane surface area in FO, AFO and AFO-NF modes

### DETAILED DESCRIPTION OF THE INVENTION

The various embodiments of the invention are described hereinafter with reference to the accompanying drawings, in which embodiments of the invention are shown. However, the various embodiments may be embodied in many different forms and should not be construed as limited to the embodiments set forth herein. Rather, these embodiments are provided to illustrate various aspects of the invention.

Aspects of embodiments of the invention are disclosed in the following description and related drawings directed to specific embodiments of the invention. Alternate embodiments may be devised without departing from the scope of the invention. Alternate embodiments arising out of combination of the embodiments are well within the scope of the present invention as will be evident to a person skilled in the art. Additionally, well known elements of the invention will not be described in detail or will be omitted so as not to obscure the relevant details of embodiments of the invention. The terminology used herein is for the purpose of describing particular embodiments only and is not intended to be limiting the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity

The present invention is generally to apply membrane processes using hydraulic and osmotic pressure for water transfer from a lower salinity solution to a higher salinity solution. Modifications and variations to the methods and apparatus of the present invention will be known by a skilled person of this disclosure. Such modifications and variations are deemed within the scope of the present invention.

In osmotic pressure driven processes, hydraulic pressure plays a role as well as the specific properties of the membrane in the efficiency of the process. Therefore, the general equation governing water transport in osmotic processes based on solution-diffusion theory becomes:

J_{W}=A·(Δπ+ΔP) Equation 1
Where J_{W} is the water flux (L·⁻²·h⁻¹), A is the pure water permeability (L·⁻²·h⁻¹·Bar⁻¹), Δπ is the osmotic pressure differential (bar) and ΔP is the hydraulic pressure differential (bar).

As described in equation 1, hydraulic pressure could be used to enhance water flux in osmotic pressure driven system. However, In FO system, hydraulic pressure has not been considered since FO is considered solely as an osmotic driven process.

Only very recently, the newly developed concept known as, PAO (pressure assisted forward osmosis) has been developed. The process aims at pressurizing the feed solution of FO to enhance water flux through the membrane by combining osmotic and hydraulic pressures effects. Studies have confirmed the beneficial impact of additional hydraulic driving force not only in enhancing the water permeation flux but also by limiting reverse salt diffusion. However, the beneficial impact of hydraulic pressure in the state of the art is limited due to the relatively low permeability membrane used.

Therefore the current invention proposes to combine the specific interest of PAO configuration (higher water flux, low reverse salt diffusion) with higher permeability membrane (typically NF membrane) in order to optimise the beneficial impact of hydraulic pressure. This specific configuration has not yet been described in the state of the art and confers very specific and novel positive advantages to overcome actual limitations of the state of the art.

The invention could be of application in any process considering particularly in the context of liquid foods concentration in food applications, enrichment of pharmaceutical products (e.g. protein and lysozymes), water purification, reuse and recovery from impaired water sources, and desalination.

The specification will for clarity describe the process in terms of salinity however it will be understood by a person skilled in the arty that the “salt” of the salinity my be substituted for any number of compounds not technically salts but that have osmotic characteristics.

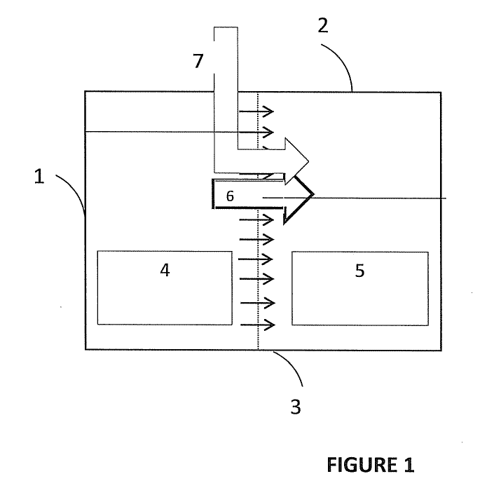

FIG. 1 schematically demonstrates PAO-NF concept. The water permeation through the NF membrane (3) from the first compartment (1) having a low salinity solution (4) to the second compartment (2) having a high salinity solution (5) is enhanced thanks to the combination of osmotic pressure gradient (6) i.e. the natural force of water to travel from a solution of low salinity to a solution of high salinity and the application of hydraulic pressure (7) on the first compartment (1)

The FO unit operates with assistance from hydraulic pressure (7) applied to the feed solution in the first compartment (1) containing a low salinity solution (4) Typically the applied hydraulic pressure (7) is comprised but not limited to 1 to 6 bar to have a significant impact on liquid transport form the low salinity solution (4) to the high salinity solution (5) but limiting the additional energy costs due to the pressurisation. The FO process consists of the feed and draw solutions which are separated by a semi permeable NF membrane (3). The semi permeable NF membrane (3) described in the invention is defined by its molecular weight cut-off. Typically but not limiting, the molecular weight cut-off is comprised of between 50 and 1000 Dalton.

In the specific configuration of the present invention, hydraulic and osmotic forces are in the same direction and in opposition to the solute flux. While solute permeability increase of the membrane has been observed while hydraulic pressure is applied, the reverse solute diffusion remains relatively low in PAO conditions there for achieving good permeate quality.

In opposition to osmotic pressure, hydraulic pressure acts as a driving force on the water flux but not on the solute flux. Therefore PAO constitutes a way to overcome the permeability-selectivity trade-off.

One of the important economic limitations in the development of FO process is the requirement of a larger membrane surface area needed due to the low permeation flux produced. With the current invention proposed, the higher water permeation flux achieved would offset the need to have a large membrane surface area leading to a decrease in capital costs.

The second important economic limitation in the development of FO process is the replenishment cost of the draw solution. As an example and based on the current state of the art, the use of NaCl as a draw has been reported as not a very economically viable option due to its high impact on the subsequent desalination costs and relatively high reverse salt diffusion (Js/Jw=0.1 g·L⁻¹). With the methods and techniques of the present invention, the Js/Jw ratio obtained is an order of magnitude less and could comparatively make the process viable leading to a significant decrease in costs per m³ of produced fresh water.

TABLE 1
Initial economic comparison of FO and PAO
with commercial CTA FO and NF1 membranes

| | | FO | PAO (2 bar) | |
|---|---|---|---|---|
| | | CTA FO | CTA FO | NF1 |
| Capital costs | Membrane | High | medium | low |
| Operational costs | draw replenishment | High | high | low |
| | feed pump energy | Low | medium | medium |
| Performances | Feed recovery | medium | medium | high |

As described in Table 1, PAO-NF configuration appears to be the optimised configuration due to low capital costs and high performances. Interestingly, observed performances could be translated as economic interests for both artificial draw and hybrid systems.

FO and NF membranes used in PAO process highlighted two very distinct methods of operation. FO membrane showed comparatively low water permeability but low concentration polarisation (CP) making it the most appropriate separation device in conventional FO configuration, where the process is essentially osmotically driven.

On the other hand, NF membrane leads to CP which is considered detrimental to osmosis based process. However, high water permeability is unexpectedly achieved in PAO-NF configuration. In PAO-NF configuration, both hydraulic and osmotic pressure driving force contribute to water permeation.

Above 1 bar hydraulic pressure, the use of NF membrane was the most advantageous configuration. Despite higher solute permeability, no reverse salt diffusion was observed thanks to the concentration polarisation that acts as a salt barrier even for monovalent salts.

The application of PAO-NF system should not be limited to FO-RO hybrid system and the process presents advantages to much broader range of FO applications. Unlike conventional FO systems, PAO-NF process is driven by both hydraulic and osmotic pressures. While most of the studies focus on reducing CP, this phenomenon is used for positive effect in PAO-NF as a further salt barrier limiting reverse salt diffusion. Therefore, PAO-NF represents a fully distinct process in contrast to FO and NF.

As for FO, unlike NF, the process is constituted of two solutions on both sides of the membrane which are interacting. Also the hydraulic and osmotic pressure driving forces are in the same direction whereas in conventional NF part of the hydraulic pressure is used to overcome osmotic pressure similar to that for RO, therefore PAO-NF offers an improved use of hydraulic pressure.

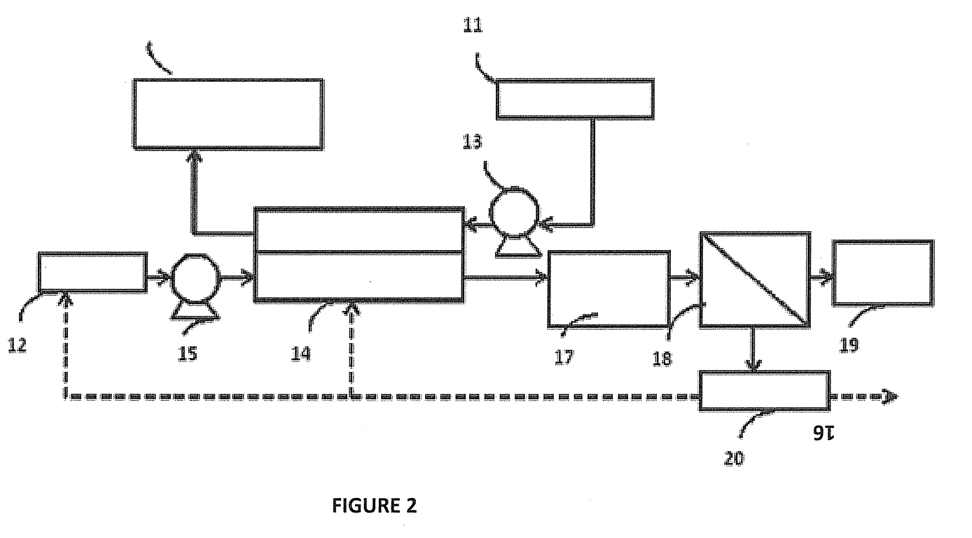

In one embodiment of the invention, illustrated in FIG. 2 the concept could be applied to the pre-dilution of seawater before RO desalination. A relatively low solute water (11) usually being impaired in some way could be sourced from one or more of the following sources including waste water, storm water, recycled water is used as feed and a high solute water (12) as a draw solution from one or more of the following sources including seawater, RO brine, surface water, groundwater. The low salinity solution (11) is pressurised by pressure pump (13) and pumped through the NF membrane module (14) at a moderate pressure (1-6 bar) while the high solute water (12) is pumped through the NF membrane module (14) at a low pressure through transfer pump (15) to allow for water transfer through the system leading to a high rate of water permeation through the NF membrane module (14) and dilution to the high solute water (12) and concentration of low solute water (11) to generate a concentrated low solute water (16). The diluted high solute solution (17) is further processed through a RO system (18) in this case a lower pressure RO system than would otherwise be required to produce fresh water (19) and the brine (20) is disposed or reinjected in the system

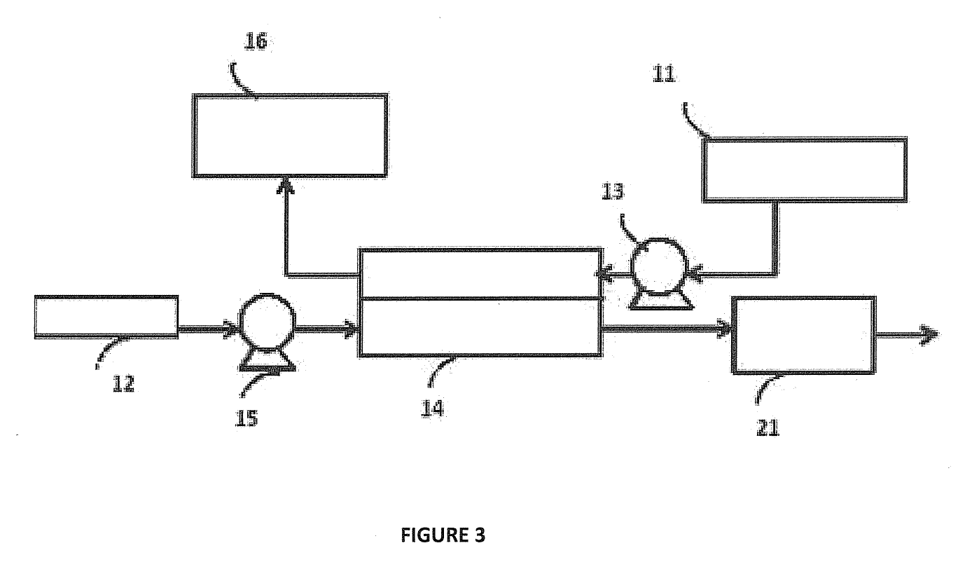

Another potential application of the invention is the fertigation process in which the fertiliser was diluted by using an impaired water source as shown in FIG. 3. The impaired water or low solute water (11) is pressurised by pressure pump (13) and pumped through the NF membrane module (14) at a moderate pressure while the fertiliser solution or high solute water (12) is pumped through the module (14) by transfer pump (15) at a low pressure leading to a high rate of water permeation through the NF membrane and production of a concentrated low solute water (16) and diluted fertiliser (21) for either direct use or further dilution and spreading on land. In such application,

The invention presents the advantage in comparison with traditional FO to reach a higher dilution rate allowing using the fertiliser directly or with reduced need for further dilution after this step of process

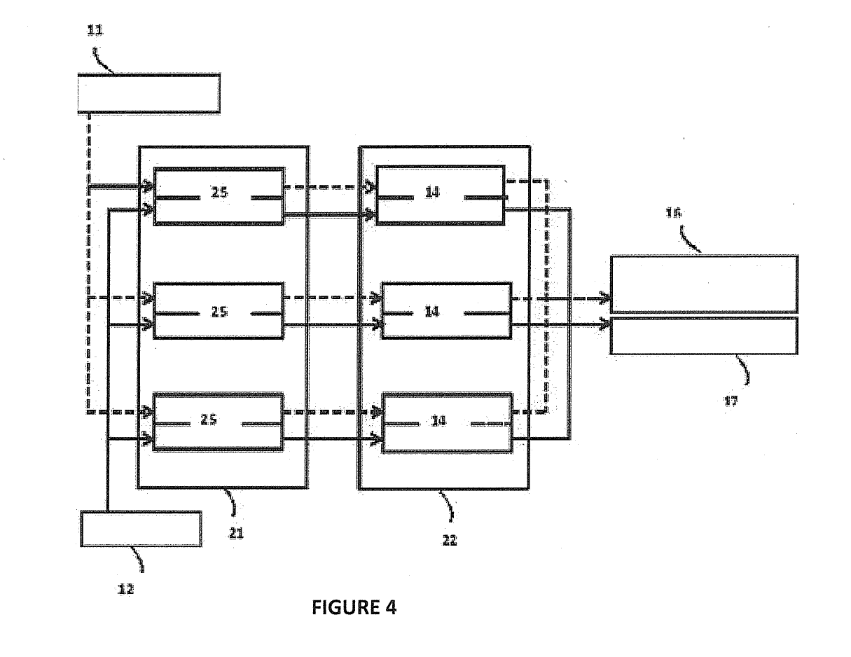

Another possibility is to use PAO-NF as a complementary step to a FO system in order to compensate the initial loss of osmotic pressure gradient to increase recovery. The FIG. 4 describes the osmotic dilution of high solute water (12) by low solute water (11) In a first stage (21) several parallel vessels containing FO membrane modules (25) are used. The PAO-NF concept is applied in a second stage (22) using NF membrane module (14) and a booster pump (not shown) located between the first stage (21) and the second stage (22) to boost the pressure of the low solute water (11) exiting the first stage (21) before it enters the second stage (22) and further enhance the permeation flux. Thus producing a diluted high solute solution (17) and a concentrated low solute solution (16)

One of the advantages in using this system where the low solute water is an impaired water source is that you provide a barrier for transfer of pathogens from the impaired feedwater to the diluted draw solution. This is particularly beneficial of the draw solution is to be used for potable application or direct application n to agriculture.

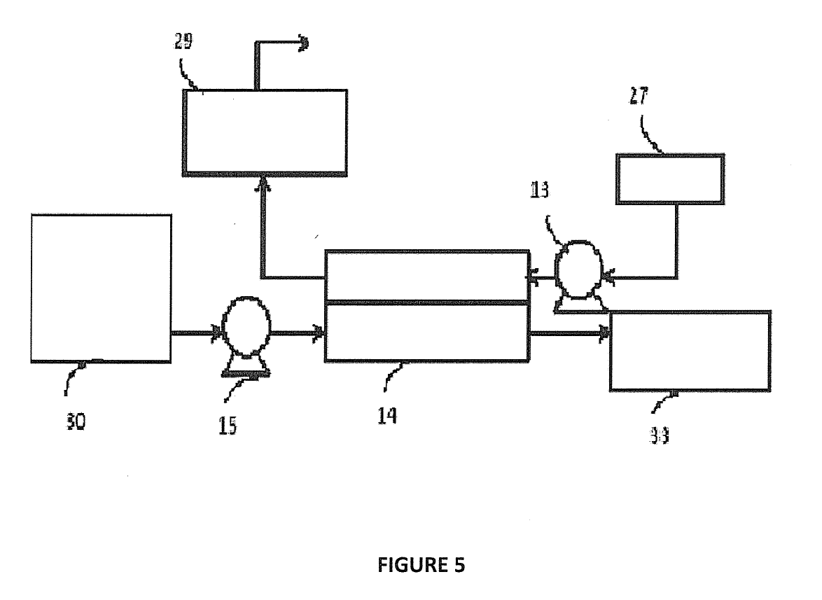

Another potential application of the invention is the concentration of liquid foods such as fruit juice concentration, concentration of sugar (sucrose) in formulation of jams, marmalades, bakery products, candies, and concentration of whey The FIG. 5 shows an example of the concentration of sugar solution derived from sugar cane or sugar beet, which is a common practise in many food industries. The sucrose solution (27) is pressurised and pumped through the NF membrane module (14) at a moderate pressure through the pressure pump (13) while a draw solution of higher osmotic pressure (for example sodium chloride solution) (30) is pumped through the NF Membrane module (13) at a low pressure via transfer pump (15) leading to a high rate of water permeation through the NF membrane and production of a dilution to the draw solution (33) and a concentration of the concentration of sucrose solution. (27)

In such application, the invention presents the advantage as an alternative to other dewatering practices to reach a higher concentration factor allowing the direct use of concentrated sucrose solution (29) in formulation of jams, marmalades, and candies.

### EXAMPLES

The invention is further illustrated by the following laboratory examples, which, however are not to be constructed as limiting the invention.

In this section, the experimental methods used to generate the results in the examples are described in details. This includes the detailed membrane characteristics of both NF and HTI FO membranes as listed in Table 2, feed and draw solutions used as listed in Table 3 and PAO-NF set up used for the separation and extraction of solvent from a feed to a draw solution using both NF and FO membranes.

### Experimental Methods

### Characterisation of Membranes

A flat-sheet cellulose triacetate (CTA) FO membrane manufactured by HTI (Albany, Oreg.) was used as a reference in these experiments. This is a commercially available membrane, which is used as the main industrial reference in FO process and is also widely used in all scientific publications. Six flat-sheet commercially available NF membranes were also tested, and they are named as NF1, NF2, NF3, NF4, NF5 and NF6. These NF membranes were selected to be representative of a wide range of molecular weight cut off and surface chemistry.

Pure water permeability (A) and salt permeability (B) have been measured in a bench scale FO setup at 25° C., with CFV (cross flow velocity) of 0.1 m·s⁻¹ and in the range of 2 to 5 bar applied hydraulic pressure. A was measured with Milli-Q water and calculated as a function of permeation flux and applied hydraulic pressure as described in Eq. 2:

$$A = \frac{J w}{Δ P} \qquad Equation 2$$

Solute permeability (B) was evaluated using 0.5 g/L red sea salt as the feed solution using Eq. 3. Salt permeability can be determined from the measured water flux and salt rejection as shown in Eq. 4. Salt rejection was calculated based on the salt concentration in feed and permeate solutions, which were determined by conductivity measurement.

$$\begin{matrix}B = J w \cdot ( \frac{1 - R}{R} ) exp ( - \frac{J w}{k} ) & Equation 3 \\ R = 1 - ( \frac{Cp}{Cf} ) & Equation 4\end{matrix}$$

where R is the salt rejection, k is the cross-flow mass transfer coefficient, C_{f} and Cₚ are the salt concentration in the feed and permeate respectively. The value ‘k’ was found to be 7.23×10⁻⁵ m·s⁻¹ in this configuration, and the calculation was based on correlation for flat channel filled with spacer. Detailed membrane characteristics of both NF and HTI membranes used were obtained from the experimental results as summarised in Table 2.

TABLE 2
Detailed membrane characteristics
of both NF and HTI membranes used

| | | | Perme- | Solute | Conduc- |
|---|---|---|---|---|---|
| | | | ability, A | diffusivity, B | tivity re- |
| Membrane | MWCO | Membrane | L · m⁻² · | (×10\hat{ }⁻⁵ | jection, R |
| Type | (Da)^{a} | Materials | h⁻¹ · bar⁻¹ | m · s⁻¹) | (%) |
| CTA | | Cellulose | 0.6-1.2 | 0.017-0.05 | 70-91 |
| | | triacetate | | | |
| NF1 | 90-100 | Polyamide | 9.8 ± 0.4 | 0.19 | 84 ± 1 |
| NF2 | 300 | Polyamide | 18.9 ± 0.4 | 4.79 | 24 ± 2 |
| NF3 | 200 | Polyamide | 8.2 ± 0.6 | 0.32 | 70 ± 4 |
| NF4 | 1000 | Sulfonated | 13.4 ± 0.3 | 11.1 | 12 ± 1 |
| | | Polyether- | | | |
| | | sulfone | | | |
| NF5 | 150 | Proprietary | 7.4 ± 0.1 | 0.90 | 45 ± 2 |
| NF6 | 600-800 | Modified | 11.6 ± 0.1 | 4.4 | 16 ± 2 |
| | | Polyether- | | | |
| | | sulfone | | | |

Feed and Draw Solution

The draw solution was prepared using dry Red Sea seawater salts (i.e. Coral Pro salt supplied by Red Sea Inc.) at a concentration of 35 g·L⁻¹ (in Milli Q Water). The osmotic pressure (n) of the solution was calculated to be 24.7 bar which is based on the composition of the red sea salts using ROSA software (DOW Chemical).

Different feed solutions were prepared using humic acid sodium salt (Aldrich, Milwaukee, Wis.), calcium chloride dried 1.5-2.5 mm (Ajax Finechem Pty Ltd, Tarend point, Australia), red sea salts and alginic acid sodium salt (Sigma Aldrich Co., St Louis, Mo.) to mimic the real wastewater. Humic acid and sodium alginate were used as model organic foulants since they have been identified as major organic components in wastewater and extensively used in fouling studies for osmotic processes. Red sea salt was used to evaluate the impact of ECP. Also, as FO fouling remains as a limitation and since PAO application could be dedicated to high feed recovery, high level of model foulants were chosen and calcium chloride was added together with alginate in order to enhance fouling phenomena. The following feed solutions were used during the experiments as shown in Table 3.

TABLE 3
Feed solution compositions

| | | | Calcium | Sodium | Humic |
|---|---|---|---|---|---|
| | | RSS | chloride | alginate | acid |
| | Milli | (1200 mg · | (220 mg · | (200 mg · | (200 mg · |
| | Q | L⁻¹) | L⁻¹) | L⁻¹) | L⁻¹) |
| Feed 1 | X | | | | |
| Feed 2 | X | X | | | |
| Feed 3 | X | | X | X | X |
| Feed 4 | X | X | | | X |

PAO-NF Setup

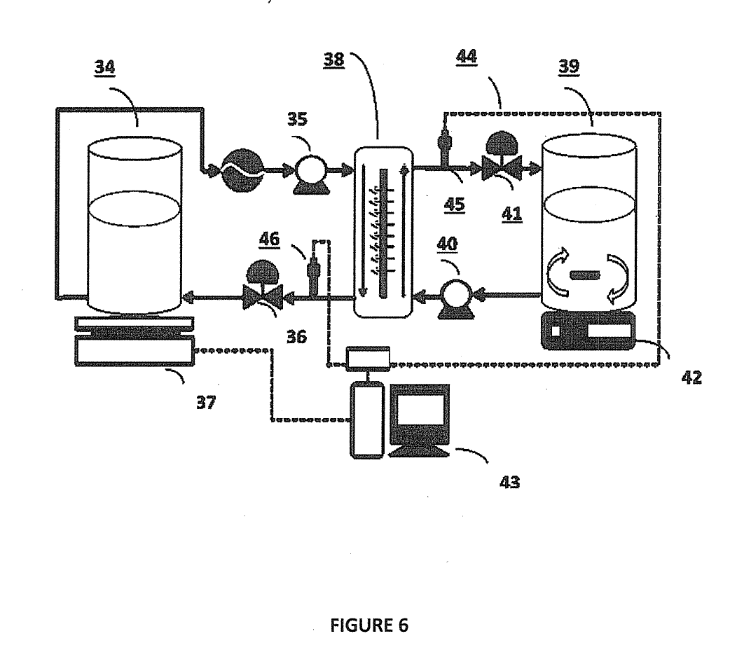

The FIG. 6 describes a schematic representation of the PAO filtration rig. PAO set up comprises of a draw solution tank (34), a draw solution feed pump (35), a draw solution control valve (36), a draw solution balance (37), a FO membrane cell (38), a feed tank (39), a feed pump (40), a feed control valve (41), a feed stirring plate (42), a PC (43) and data logger (44), pressure transmitters (45, 46). All These components represent the PAO apparatus.

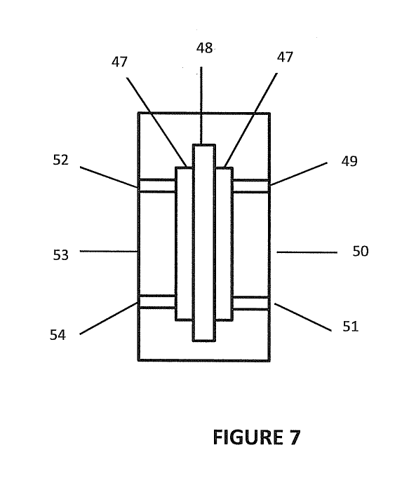

The details of the FO membrane cell (38) are shown in FIG. 7. The FO membrane cell (38) includes feed spacers (47), a membrane (48), a feed side (50), a feed side input (51), a feed side output (49), a draw side (53), a draw side input (52) and a draw side output (54).

All the experiments in PAO configuration were conducted with the exemplary apparatus as shown in FIGS. 6 and 7. The draw solution (34) and the feed solution (39) were circulated by a draw pump (35) and a feed pump (40). Both draw and feed pumps are Masterflex peristaltic pumps and the flow rates of the pumps were calibrated beforehand. The feed pump (40) was adapted with a high pressure pump head. The temperature was regulated at 25° C. using a thermo-bath on the draw solution loop where a stainless steel cooling coil was installed to maximize the heat exchanges. The experiments were started with 2 L of both feed solution (39) and draw solution (34), and the system was run at CFV of 0.1 m·s⁻¹. In the FO membrane cell (38), feed spacers (47) were used by default on both sides of the membrane (48). The pressure on the feed side (50) was regulated manually with a feed control valve (41) of the feed side output (49) of the membrane cell (38), monitored with in-line feed pressure transmitters (45) from Labom Measurement Technology, and recorded with National Instrument data acquisition (44). Applied pressure on the feed side (50) varied from 0 to 6 bar.

The water flux across the membrane (48) from the feed side (50) to the draw side (53) was calculated by measuring the mass of the draw solution using analytical balance (37) over time, recording the data with a computer (43). All tests have been conducted with active layer facing feed water (AL-FS) membrane orientation except for the tests conducted for Example 2 in which AL-DS membrane orientation was assessed. Salt content of both feed solution (39) and draw solution (34) were calculated based on conductivity measured with an Oakton conductivity meter. This was used to calculate osmotic pressure of solutions as well as reverse salt diffusion.

Water permeability and salt rejection are good indicators of membrane characteristics but they are not representative of PAO configuration where solute and water fluxes are in opposite direction. Therefore, the Jₛ/J_{w} ratio, also called reverse salt diffusion ratio was also measured.

### Example 1

### Impact of Hydraulic Pressure

Initial tests were performed with Milli Q water and 35 g·L⁻¹ of red sea salt as feed and draw solution respectively for CTA FO and NF1 membranes. Each test was run in order to obtain a stabilised system for the duration of at least 2 hours. Water flux was recorded after the system was stabilised. Tests were performed without hydraulic pressure (FO mode) and with 2 bar applied hydraulic pressure (PAO 2 bar). Results are presented in Table 4:

TABLE 4
CTA FO vs. NF1 on FO and PAO mode

| | Water permeation flux | | Reverse solute diffusion | |
|---|---|---|---|---|
| Process | (L · m⁻² · h⁻¹) | | (g · L⁻¹) | |
| configuration | CTA FO | NF1 | CTA FO | NF1 |
| FO | 7.6 | 1.2 | 0.5 | 0.34 |
| PAO 2 bar | 9.8 | 27.4 | 0.5 | <0.01 |

Initially, without application of hydraulic pressure (FO), very low water permeation flux was observed with NF1 membrane (1.2 L·⁻²·h⁻¹), much lower than CTA FO one (5.6 L·⁻²·h⁻¹) despite its expected higher water permeability. This confirms the poor performance of commercial NF membrane in FO application due to high concentration polarization. The application of hydraulic pressure unexpectedly resulted in a disproportionate increase of the permeation flux up to approximately 27 L·⁻²·h⁻¹ when 2 bar pressure was applied. This unexpected performance improvement represented a more than 700% increase in permeation flux in the FO context. Permeation flux was improved and reverse salt diffusion was negligible in PAO configuration with the tested NF membrane than with the CTA FO membrane. This demonstrates that the specific combination of using PAO configuration and NF membrane leads to unexpected results and better performance than all other tested configurations.

### Example 2

### Active Layer Facing Draw Side (AL to DS)

Following the same methodology and feed solution used in example 1 and draw solution as 35 g·L⁻¹ RSS, additional tests were performed with NF1 membrane in which the active layer of the membrane were faced with draw solution (AL-DS) to assess the impact of membrane configuration. The results of this test is sown in Table 5

TABLE 5
Water permeation flux (L · m⁻² · h−1)
and reverse solute diffusion (g · L−1) during
PAO-2 bar experiments conducted for NF1 membrane
at AL-FS and AL-DS configurations

| Membrane | Water permeation flux | Reverse solute diffusion |
|---|---|---|
| configuration | (L · m⁻² · h⁻¹) | (g · L⁻¹) |
| AL-FS | 27.09 | <0.01 |
| AL-DS | 26.46 | <0.01 |

In order to assess the performance of PAO process (i.e. PAO 2 bar), NF1 membrane was tested in AL-DS mode. When tested at 2 bar in AL-DS mode using RO permeate spacer on draw side, the water permeation flux was similar to AL-FS configuration.

### Example 3

### Impact of Different NF Membrane Types

Following the same methodology and feed solution used in example 1 and draw solution as 35 g·L⁻¹ RSS, additional tests were performed with above mentioned NF membranes and with three different hydraulic pressures of 2, 4 and 6 bar.

TABLE 6
Water permeation flux (L · m⁻² · h⁻¹) performances of diverse
NF membranes with three applied hydraulic pressures

| | Pressure (bar) | | |
|---|---|---|---|
| | 2 | 4 | 6 |
| CTA FO | 9.8 | 11.8 | 12.6 |
| NF1 | 27.4 | 49.01 | 67.5 |
| NF2 | 35.1 | 79.5 | 140.2 |
| NF3 | 23.8 | 44.1 | 62.4 |
| NF6 | 16.2 | 43.5 | 77.4 |

This example referring to the data in Table 6 confirms that the increase in the water permeation flux with increasing the applied hydraulic pressure. More specifically, hydraulic pressure increase offers a much greater flux improvement with NF membranes. At applied pressure of 6 bar, NF2 membrane led to a permeation flux of approximately more than 10 and 18 times compared to CTA FO membrane in PAO 6 bar and FO configurations. This example also confirms flux enhancement for a wide range of commercial NF membranes. When a wide range of commercial NF membranes were tested to confirm the water flux enhancement at PAO 2 bar, it was observed that the highest and lowest permeability membranes, NF2 and NF5 respectively, gave the highest and lowest water flux values (35.1 and 15.8 L·⁻²·h⁻¹ respectively).

### Example 4

### Feed Water Quality on NF1 Membrane

In order to observe the impact on the water flux due to the quality of the feed solutions used, tests were run using the NF1 membrane at PAO 2 bar (operating pressure). ‘Three’ feed solutions above-mentioned in Table 3 were used in these tests while the draw solution concentration used was kept as 35 g·L⁻¹. The permeation flux at the beginning of the operation and after 50% of recovery for each feed solution is presented in the following table:

TABLE 7
Permeation flux for four feed solutions using
NF1 membrane at 2 bar operating pressure

| | Initial water | Water flux after |
|---|---|---|
| | flux | 50% recovery |
| | (L · m⁻² · h⁻¹) | (L · m⁻² · h⁻¹) |
| Feed 1 | 26.5 | 26.5 |
| Feed 2 | 15.3 | 11.4 |
| Feed 4 | 18.2 | 17.1 |

Referring to the results shown in table 7 It is first observed for ‘Feed 1’ that thanks to the high efficiency of the hydraulic pressure and the absence of reverse salt diffusion, no decrease of permeation flux is observed after 50% recovery despite the decrease of the osmotic pressure driving force. This is different from typical observation in FO, and also this constitutes as an important advantage of the invention to run at a high recovery. As for traditional FO, the presence of salt and foulants in the feed solution leads to decrease in performance. When used ‘Feed 2’ and ‘Feed 4’, there was a slight decrease in water permeation flux due to a consequence of external concentration polarisation (ECP). However, when used ‘Feed 2’ and ‘Feed 4’ with this high salt rejection NF membrane (NF1), the water flux performance was still maintained and remained higher than the result observed using HTI CTA membrane in FO (7.6 L·⁻²·h⁻¹) and PAO 2 bar (9.8 L·⁻²·h⁻¹) configurations.

### Example 5

### Impact of Fouling

To further evaluate the impact on the water flux due to the feed quality used for the present invention, tests were conducted using ‘Feed 3’ which composed of a mixture of organic foulants to mimic the real wastewater compositions. Tests were run with the three aforementioned commercial NF membranes and CTA FO membrane at 2 bar applied hydraulic pressure.

TABLE 8
Separation performances of tested CTA
FO membrane and commercial NF membranes

| | Initial water | Water permeation flux at |
|---|---|---|
| | permeation flux | 50% recovery |
| | (L · m⁻² · h⁻¹) | (L · m⁻² · h⁻¹) |
| CTA FO | 5.5 | 4.5 |
| NF1 | 10.8 | 6.5 |
| NF2 | 35.1 | 33.2 |
| NF3 | 7.6 | 5.0 |
| NF4 | 15.1 | 12.2 |
| NF5 | 8.1 | 6.4 |
| NF6 | 20 | 20 |

The initial water permeation flux observed was the highest with high molecular weight cut-off NF membranes (NF2, NF4 and NF6). In comparison with NF2, NF4 and NF6 membranes, the initial water fluxes observed for NF1, NF3 and NF5 membranes were lower; however the lowest water permeation flux was observed with CTA FO membrane. These results also demonstrate that in case of a low feed salinity and/or low needed degree of salt rejection, a higher molecular weight cut-off NF membranes such as NF2, NF4 or NF6 will be preferable leading to high water permeation flux, negligible reverse salt diffusion and constituting still a good barrier against bigger molecules, colloids or suspended solids.

### Example 6

### Modelled Water Flux Performance

Commercial NF membranes proved to have very interesting performance but they are still limited in PAO-NF process due to their thick support layers which create concentration polarisation and limit the efficiency of the osmotic pressure. Such thick support layer is not needed for PAO process, so there is a potential for developing a membrane with improved properties (for example, a thinner support layer). Therefore, in addition to the experimental observations on existing commercial NF membranes, a model was developed following the classical equations of the solution diffusion theory which drives the water permeation through a dense membrane layer, to further evaluate the interest of the use of NF membranes with modified characteristics in the scope of the invention. External concentration polarisation (ECP), internal concentration polarisation (ICP) and reverse solute diffusion were considered based on membrane characteristics, applied osmotic and hydraulic pressures and membrane setup properties.

In that context, pure water and solute permeability (A and B) are representative of the active layer of the membrane and are key elements. S, the structural parameter is representative of the support layer; the higher it is the more intense is the internal concentration polarisation limiting the water permeation flux in osmotic processes. HTI CTA FO and NF1 membrane characteristics were used as references; and two scenarios were considered as potential for the NF support layer improvement; 1) considering that the support layer is similar to the HTI CTA FO membrane, and 2) considering that NF1 without a fabric support layer. The membrane properties used for calculation as well as the calculated permeation flux were obtained while simulating a ‘Feed 2’ which was described in the following table:

TABLE 9
Modelled water permeation flux (L · m⁻² · h⁻¹) performances
of potential membrane development for PAO-NF

| | A | | | | | |
|---|---|---|---|---|---|---|
| | L · m⁻² · | B | S | Pressure (bar) | | |
| | h⁻¹ · bar⁻¹ | ×10⁻⁷ m · s⁻¹ | ×10⁻⁶ m | 2 | 4 | 6 |
| CTA FO | 0.55 | 0.48 | 678 | 7.9 | 8.7 | 9.4 |
| NF1 | 11.2 | 14 | 10000 | 13.2 | 29.9 | 44 |
| NF1 with CTA | 11.2 | 14 | 678 | 30.9 | 38.9 | 48.6 |
| FO like support | | | | | | |
| layer | | | | | | |
| NF1 without | 11.2 | 14 | 10 | 94.4 | 100.4 | 106.2 |
| support layer | | | | | | |

It has been observed first that the developed model was relevant, leading to similar permeation value than the one observed experimentally with HTI CTA FO and NF1 membrane. This also confirmed the advantage of using NF membrane in the context of PAO. More interestingly, the simulated NF1 membrane led to massive further flux improvement even with limited applied hydraulic pressure (2bar) when the support layer thickness, denoted as ‘S’, of NF1 membrane is similar to CTA FO. Significant modelled flux improvement was also observed when ‘S’ was reduced to almost 10×10⁻⁶ m.

### Example 7

### Modelled Economic Feasibility of PAO-NF

A model has been developed to estimate the evolution of the permeation flux and the recovery (percentage of feed passing on the draw side) along the process. Three configurations were compared: FO and PAO 2 bar with CTA FO and NF1 membranes, using Milli Q as feed and 35 g·L⁻¹ red sea salt as draw solution.

TABLE 10
Modelled needed membrane surface
area in FO, AFO and AFO-NF modes

| | | Membrane surface | Membrane surface |
|---|---|---|---|
| | | area to reach 50% | area to reach 90% |
| | Operating | recovery | recovery |
| Membrane | conditions | (m² · m⁻³ · h⁻¹) | (m² · m⁻³ · h⁻¹) |
| CTA FO | FO | 110 | 250 |
| CTA FO | PAO (2bar) | 65 | 137 |
| NF1 | PAO (2bar) | 22 | 40 |

Based on this model, as a reference situation in FO configuration (CTA FO), due to the moderate water permeation a membrane surface area of about 110 m²·m⁻³·h⁻¹ is required to reach 50% recovery. When hydraulic pressure is applied on the feed (PAO 2 bar using CTA FO), water permeation is enhanced due to additional driving force, 50% recovery could be reached using 60 m²·m⁻³·h⁻¹, i.e. 60% of the membrane surface area used in FO conditions which represents a significant improvement. More interestingly, in the PAO-NF process, further improvements are available. 50% recovery could be reached with 20% of the initial membrane surface area.

This result is unexpected and disproportionally high compared to FO membranes use in the PAO configuration. The use of the invention also leads to a high recovery with still a very low membrane surface area. Thus, the invention offers both advantages of limiting the capital investment costs due to low surface area but also a better efficiency of the process in terms of feed concentration or water recovery.

1. An assisted osmotic separation process for enhancing the solvent permeation and extraction of a solvent from a first solution with low osmotic pressure into a second solution within higher osmotic pressure separated by a semipermeable membrane wherein a hydraulic pressure is applied to the first solution such that hydraulic pressure being higher on the side of the semipermeable membrane in contact with the low osmotic pressure solution, wherein the membrane is a membrane defined by its molecular weight cut-off comprised in the range of 50-1000 Dalton.

2. (canceled)

3. The process of claim 1, wherein the applied hydraulic pressure is in the range of 0.1 to 20 bar.

4. The process of claim 1, wherein the applied hydraulic pressure is in the in the range of 0.5 to 15 bar.

5. The process of claim 1, wherein the applied hydraulic pressure is in the range to 1 to 10 bar.

6. The process of claim 1, wherein the pressurisation is obtained through the pumping system.

7. The process of claim 1, wherein the solvent is water.

8. The process of claim 1, wherein the low osmotic pressure solution is chosen from one of the following waste water, storm water, recycled water.

9. The process of claim 1, wherein the high osmotic pressure solution is chosen from one of the following seawater, reverse osmosis brine, surface water, ground water, fertilizer solution, sugar solution.

10. A system for osmotic separation process for the extraction of a solvent from a first solution with low osmotic pressure into a second solution with higher osmotic pressure separated by a semipermeable membrane wherein a hydraulic pressure is applied to the first solution such that hydraulic pressure being higher on the side of the semipermeable membrane in contact with the low osmotic pressure solution to enhance the water permeation from the first solution to the second solution, wherein the semipermeable membrane has molecular weight cut-off in the range 50-1000 Dalton.

11. The system of claim 10, wherein the applied hydraulic pressure is in the range of 0.1 to 20 bar.

12. The system of claim 10, wherein the applied hydraulic pressure is in the in the range of 0.5 to 15 bar.

13. The system of claim 10, wherein the applied hydraulic pressure is in the range to 1 to 10 bar.

14. The system of claim 10, wherein the low osmotic pressure elution is chosen from one of the following waste water, storm water, recycled water.

15. The system of claim 10, wherein the high osmotic pressure solution is chosen from one of the following seawater, reverse osmosis brine, fertilizer solution, sugar solution.

16. (canceled)

17. (canceled)

18. The system of claim 10, wherein the semipermeable membrane is Nano-filtration Membrane.
